(19) United States
(12) Patent Application Publication
(10) Pub. No.: US 2017/0255197 A1
(43) Pub. Date: Sep. 7, 2017

(54) HEAVY EQUIPMENT REMOTE STARTING SYSTEM

(71) Applicant: Scott Scott Delbert Vonasek, East Grand Forks, MN (US)

(72) Inventor: Scott Scott Delbert Vonasek, East Grand Forks, MN (US)

(21) Appl. No.: 15/598,046

(22) Filed: May 17, 2017

Related U.S. Application Data
(63) Continuation-in-part of application No. 14/957,792, filed on Dec. 3, 2015, now abandoned.

(51) Int. Cl. G05D 1/00; F02N 11/08; G05D 1/02

(52) U.S. Cl. CPC G05D 1/0027; G05D 1/0278; G05D 1/0016; G05D 1/0022; G05D 1/0038; F02N 11/0807; G05D 2201/0201; G05D 2201/0213; H04W 84/005

(57) ABSTRACT

A system, apparatus, and method to remotely control a plurality of vehicles including the use of a wireless control device that is operably coupled to the control systems of the vehicles to thereby wirelessly communicate with a smart phone through an internet network. The smart phone being capable of storing a set of instructions, which when executed by the processing unit of the smart phone allows a user to select vehicles and send instructions to the control devices in the vehicles to operate them remotely. The system further allows a user to select individual vehicles based on their location using a GPS system.

### CROSS-REFERENCE TO RELATED APPLICATION

The present application is related to and claims priority from prior application Ser. No. 14/957,792, filed Dec. 3, 2015 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The invention generally relates to an apparatus and method for use in the remote operation of a vehicle ignition system. In particular, the invention relates to the remote starting of a heavy vehicle ignition system.

2. Description of the Related Art

Vehicle remote starters have been successfully used in light vehicles for remote the operation of the vehicle's ignition system. These have been particularly useful in cold climates, wherein the vehicle takes a good amount of time to start and the engine temperature to reach operable temperature condition. Prior art discloses many advances in vehicle remote starters, such as U.S. Pat. No. 8,489,085, issued to “Dei Headquarters, Inc.,” which discloses a system and method for a remote vehicle starter with an advanced dynamic scheduling system that utilizes a cellular telephone, interfaces with standard scheduling software, and communicates through a wireless telecommunication network with a vehicle to send vehicle remote start signal. Another, U.S. Pat. No. 6,028,372, issued to “Designtech International, Inc.,” discloses a control operation for a remote vehicle starter that allows a daily automatic setting to activate the remote vehicle starter. Another, U.S. Pat. No. 7,532,959, issued to “Dei Headquarters, Inc.,” discloses a remote start method and apparatus for an engine that is coupled to a manual transmission. Another, U.S. Pat. No. 8,751,065, issued to “Denso Corporation,” discloses a vehicle control system that is configured to wirelessly communicate with a mobile device that is configured to enable the ignition system of vehicle.

Although many advances have been made in developing remote vehicle starters for lightweight vehicles, the prior art discloses no significant attempt in developing remote starters for heavy vehicle, such as tractors. Heavy vehicles require significant time to warm up, which may consume working hours of the operator. Thus, a need is appreciated for a remote ignition starter for heavy vehicles that allows the user to start the equipment prior to showing up on job site, therefore saving time and money by not having to wait for the equipment to warm up.

### BRIEF SUMMARY OF THE INVENTION

In present invention, therefore, has as its principal objective to provide a remote vehicle start apparatus for a heavy vehicle.

Another objective of the present invention is to provide a method to use the aforesaid apparatus for the remote operation of the ignition system of a heavy vehicle.

An additional objective is that the apparatus could be operated at any range from the vehicle. Yet another objective is that the apparatus is simple to use.

Certain embodiments of current invention provide an apparatus and method for remotely starting the ignition of a heavy vehicle, such as, but not limited to, a tractor, a truck, etc. The apparatus is comprised of a wireless control device that is operably coupled to the ignition system of the vehicle. The device could wirelessly communicate with a remote device, such as, but not limited to, a smart phone, through an Internet protocol network. The smart phone could be capable of storing a set of instructions, which, when executed by the processing unit of smart phone, allow the user to select the vehicle and send an instruction to start the ignition of vehicle through an Internet network.

In a preferred embodiment, the current invention provides a method to locate the position of at least one vehicle and select the vehicle based on its location. Or, the method may allow the user to select a vehicle from a group of vehicles.

In addition to the various objectives and advantages of the present invention, described with some degree of specificity above, it should be obvious that additional objectives and advantages of the present invention will become more readily apparent to those persons who are skilled in the relevant art from the following more detailed description of the invention, particularly when such description is taken in conjunction with the attached drawing figures.

### BRIEF DESCRIPTION OF THE DRAWINGS

The figures which accompany the written portion of this specification illustrate embodiments and method(s) of use for the present invention, a universal second handle constructed and operative according to the teachings of the present invention.

FIG. 1 depicts steps taken to start ignition system of a vehicle remotely.

FIG. 2 depicts a remote communication device of FIG. 1.

FIG. 3 depicts a preferred embodiment of the present invention including a plurality of vehicles.

FIG. 4 depicts the remote communication device of the preferred embodiment of the present invention.

FIG. 5 depicts a vehicle of the preferred embodiment of the present invention.

The various embodiments of the present invention will hereinafter be described in conjunction with the appended drawings, wherein like designations denote like elements.

### DETAILED DESCRIPTION

As discussed above, embodiments of the present invention relate to an outdoor implement and more particularly to a universal second handle as used to provide the ability to use a shovel with hands on two separate handles to allow greater flexibility and leverage.

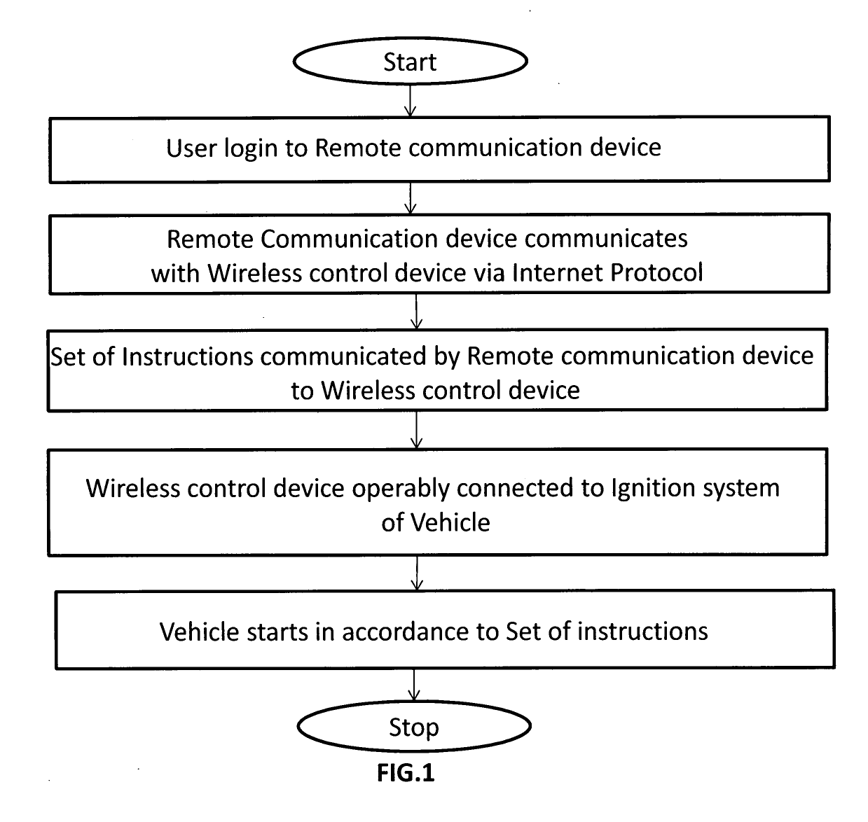

Referring to FIG. 1 shows steps taken to start ignition system of a vehicle remotely. In the first step, the user logs into the remote communication device and searches for a vehicles and its location. In second step, the remote communication device remotely connects to wireless control device via Internet. In third step, the set of instructions stored in readable memory of the remote communication device are communicated to the wireless control device. In the fourth step, the wireless control device checks a no. of equipments installed in the vehicle for example position of brake pedal, position of gear, level of engine oil etc. in accordance to the set of instructions. The position and level of various equipments are known with the help of a no. of sensors for example position sensor, level sensor, level indicator etc. In the fifth step, the ignition system is started.

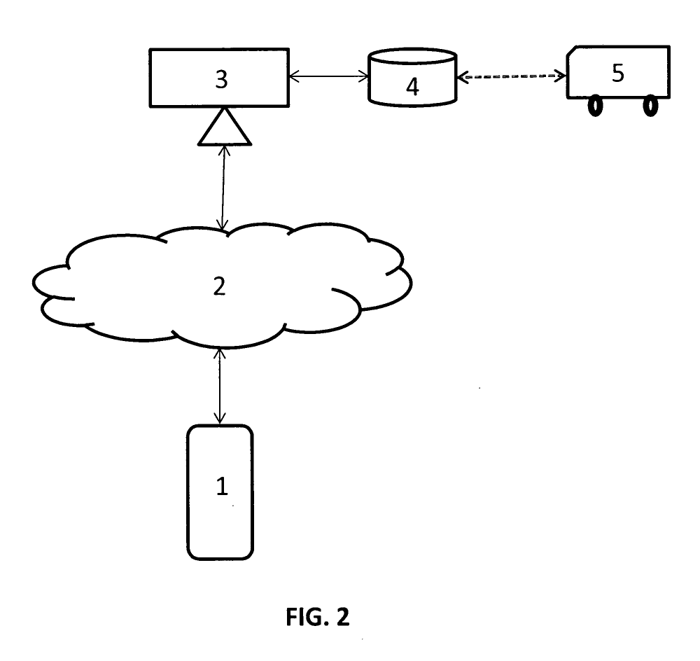

Similarly, referring to FIG. 2 shows a remote communication device (1) that has a computing system and is connected with server (2) via internet. The wireless control device (3) is also connected to the server. The vehicle's location is also provided to the user by a remote transmitter (4) installed within the vehicle. Accordingly, the user logs into the remote communication device and enables it to communicate a set of instructions to the remote control device that is operably connected to the ignition system of a vehicle (5). The ignition system is turned on remotely.

The present invention is a remote vehicle ignition starting apparatus and a method to operate the apparatus to remotely start a heavy vehicle, such as a truck, bus, tractor, etc. The invention is particularly advantageous in cold climates, wherein the present invention may allow warming the vehicle's engine to an operable temperature without the need for an operator to be present in or near the vehicle. This could save the operator time; otherwise the operator has to wait for the engine to warm-up. Thus, the present invention may allow an increase in productivity, and also save money.

Heavy vehicles are particularly difficult to start in cold climates, and the operator spends significant time in the morning to start the engine before the operator can perform their assigned work. Using the invention, the operator may send an ignition signal before reaching the worksite, such as, before leaving the home to go to the worksite. The operator, from his previous experience of starting the vehicle, may estimate the time required for starting the vehicle, and, accordingly, send the instruction to start the engine.

The apparatus is comprised of a wireless control device that is operably coupled to the ignition system of the vehicle. The control device could start the ignition automatically, without any intervention of operator or the vehicle's key inserted into the ignition. The control device could have the ability to check the status of the vehicle's transmission, such as the position of the gear or the position of the braking pad, or any other precaution that is to be observed before starting the engine of the vehicle. The control device could be powered by the electrical system of the vehicle, and could wirelessly communicate with a remote device. The remote device could be any computing device with Internet connectivity, such as a laptop, desktop, cellular phone, notepad, etc. Preferably, the remote device could be a smart phone. The control device in the vehicle could communicate to the smart phone through an Internet protocol, such as GPRS, 3G, Wi-Fi, etc. Use of Internet connectivity allows the user to operate the ignition system of the vehicle at any distance from the vehicle.

The present invention provides a set of instructions contained in the remote device, which, when executed by the processing unit of the remote device, allows the user to select the vehicle and send the instruction to the control device to start the ignition of the vehicle. The present invention provides a method to use the apparatus for the remote ignition of a vehicle. The method allows the user to locate the position of the vehicle using GPS. The vehicle could then be started by using the apparatus of present invention. For example, a user that has three identical tractors standing in different locations, such as one in the field, one on the farmyard, and another in a different field, could locate the position of each tractor on the display screen of the smart phone and choose the tractor based on its location. Thus, the user may start the vehicle without remembering its unique ID or name. The smart phone may incorporate a GPS receiver to locate the position of vehicle, wherein the control unit in the vehicle may contain the GPS transmitter. Besides the use of GPS, the invention may further use other methods to locate the object, such as using cellular phone towers, or any other methods obvious to a skilled person.

In another embodiment, the set of instructions contained in the mobile device may allow the user to select the vehicle from a group of vehicles shown on the display screen. The user may operate more than one vehicle using a single mobile device.

The control device in the vehicle may further have sensors to detect the engine oil level and communicate the same to the remote device. This could allow the user to check the oil level before sending the instruction to start the engine. Such a mechanism could prevent any damage to the vehicle and improve productivity.

A server may control the communication between the control device in the vehicle and the remote device. Such servers may also provide an interface for operating the control device, for example, a website, etc. Such method could allow the user to operate the vehicle using any remote device, such as a laptop, desktop, or a smart phone. Access to the servers could be monitored, and the user may be charged for using the services. This makes the invention commercially advantageous.

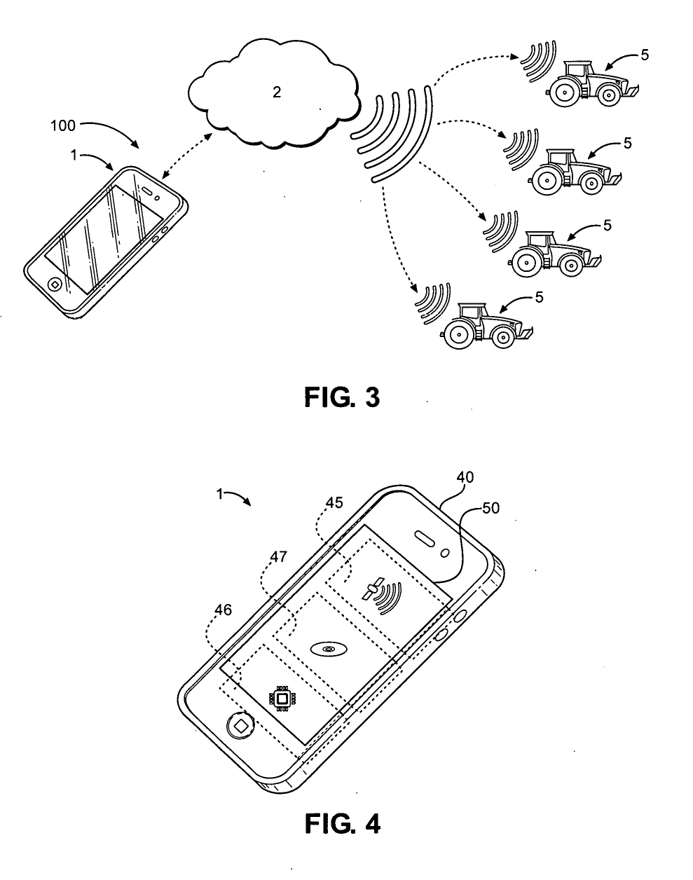

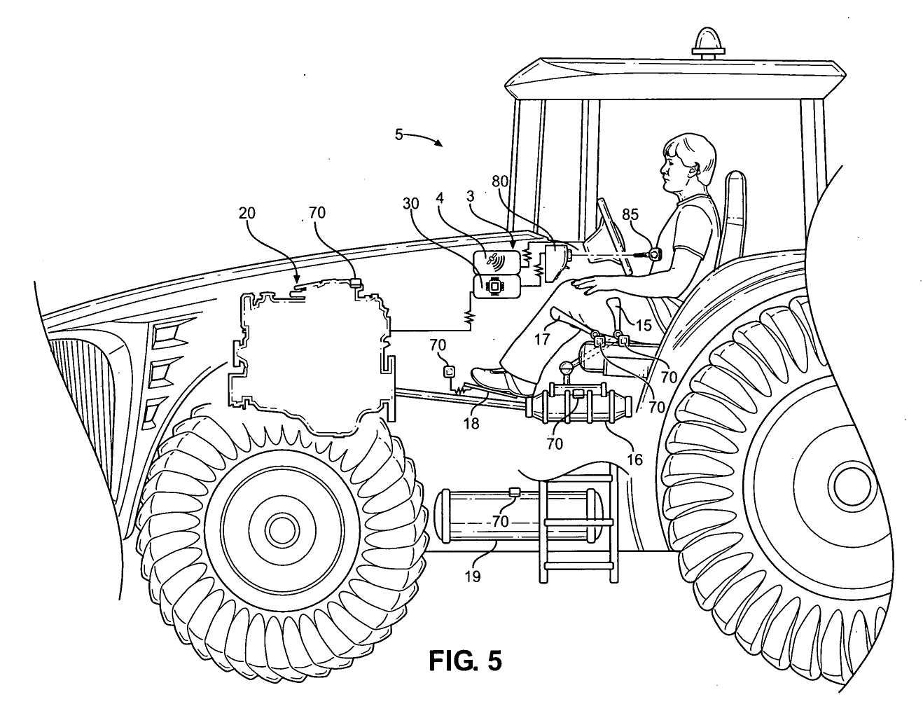

Referring now to FIGS. 3-5, a preferred embodiment of the present invention is formed as a system for remote control operation 100 of a plurality of vehicles, comprising a plurality of vehicles 5 each including a gear stick 15 adapted to control gears 16 therein, hand brakes 17, brake pedals 18; a fuel tank 19 having oil therein, an engine 20 having oil therein; and a control system 30 adapted to mechanically control each of the gear stick, hand brakes, brake pedals, and the engine; and a system for remote control operation 100 of the plurality of vehicles.

The system for remote control operation 100 of the plurality of vehicles 5 comprises a plurality of wireless control devices 3 each including a global positioning satellite transmitter 4 adapted to send positioning information to the remote communication device 1 and adapted to be operably coupled to the control system 30 of each respective one of the plurality of vehicles 5 to thereby provide vehicle control instructions thereto; and the remote communication device 1 including a computing system 40 adapted to remotely connect and communicate with each of the plurality of wireless control devices 3 and thereby connect and communicate with each control system 30 of each respective one of the plurality of vehicles 5 via an internet server 2 (such as Wi-fi, GPRS, and 3G), and a global positioning satellite receiver 45 adapted to receive and register positioning information of each of the plurality of wireless control devices 3 and thereby each of the plurality of vehicles 5, such that a user can use the remote communication device 1 to control all of the plurality of vehicles at the same time.

The remote communication device 1 can be formed as a smartphone, a tablet, a laptop, or a desktop, and include a display screen 50, a processing unit 46, a computer-readable data carrier 47, and a computer application encoded within said computing system 40 adapted to aid a user in using the remote communication device and thereby controlling all of the plurality of vehicles at the same time.

The control system 30 of each respective one of the plurality of vehicles is adapted to control the position of its gear stick 15, the position of its hand brake 17, the position of its brake pedal 18, the level of oil in its fuel tank 19, the level of its engine oil, and is capable of turning its engine on and off.

The system for remote control operation 100 further comprises a plurality of sensors 70 connected with components of each respective ones of the plurality of vehicles to determine the positions of respective gear sticks 15, the positions of respective hand brakes 17, the position of respective brake pedals 18, the levels of oil in respective fuel tanks 19, the levels of respective engine oil, and whether the engine is turned on or off; and wherein each of the plurality of sensors 70 are adapted to send information to a respective control system 30 of each respective one of the plurality of vehicles.

The system for remote control operation 100 further comprises a plurality of manual override switches 80 each adapted to be connected to each respective engine of the plurality of vehicles to provide a manual means to switch between remote control of turning said engine on and off and manual override control of turning said engine on and off. Each of the plurality of manual override switches 80 includes a key 85 adapted to be inserted and turned therein to activate manual override of said remote control of said engine.

The plurality of vehicles 5 range from trucks and buses to tractors, soil cultivators, and combines. However, all types of vehicles can be incorporated into this system.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

I/We claim:

1. (canceled)

2. (canceled)

3. (canceled)

4. (canceled)

5. (canceled)

6. (canceled)

7. (canceled)

8. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. A system for remote control operation of a plurality of vehicles, comprising:
a plurality of wireless control devices, each including:
a global positioning satellite transmitter adapted to send positioning information to a remote communication device;
wherein each of said plurality of wireless control devices is adapted to be operably coupled to a control system of each respective one of said plurality of vehicles to thereby provide vehicle control instructions thereto; and
a remote communication device including:
a computing system;
wherein said computing system is adapted to remotely connect and communicate with each of said plurality of wireless control devices and thereby connect and communicate with each said control system of each respective one of said plurality of vehicles via an internet server; and
a global positioning satellite receiver;
wherein said global positioning satellite receiver is adapted to receive and register positioning information of each of said plurality of wireless control devices and thereby each of said plurality of vehicles;
wherein a user can use said remote communication device to control all of said plurality of vehicles at the same time.

24. The system for remote control operation of a plurality of vehicles of claim 23, wherein said remote communication device is selected from a group of remote communication devices consisting of a smartphone, a tablet, a laptop, and a desktop.

25. The system for remote control operation of a plurality of vehicles of claim 24, wherein said remote communication device includes a display screen; a processing unit; a computer-readable data carrier; and a computer application adapted to aid said user in using said remote communication device and thereby controlling all of said plurality of vehicles at the same time.

26. The system for remote control operation of a plurality of vehicles of claim 23, wherein said internet server uses an internet protocol chosen from a list of internet protocols consisting of Wi-fi, GPRS, and 3G.

27. The system for remote control operation of a plurality of vehicles of claim 23, wherein said control system of each respective one of said plurality of vehicles is adapted to control the position of its gear stick; the position of its hand brake; the position of its brake pedal; the level of oil in its fuel tank; the level of its engine oil; and is capable of turning its engine on and off.

28. The system for remote control operation of a plurality of vehicles of claim 27, further comprising a plurality of sensors; wherein respective said sensors are connected with components of each respective ones of said plurality of vehicles to determine said positions of respective said gear sticks; said positions of respective said hand brakes; said position of respective said brake pedals; said levels of oil in respective said fuel tanks; said levels of respective engine oil; and whether said engine is turned on or off; and wherein each of said plurality of sensors are adapted to send information to a respective said control system of each respective one of said plurality of vehicles.

29. The system for remote control operation of a plurality of vehicles of claim 28, further comprising a plurality of manual override switches each adapted to be connected to each respective engine of said plurality of vehicles to provide a manual means to switch between remote control of turning said engine on and off and manual override control of turning said engine on and off.

30. The system for remote control operation of a plurality of vehicles of claim 29, wherein said plurality of manual override switches each includes a key adapted to be inserted and turned therein to activate manual override of said remote control of said engine.

31. A remote controlled vehicle system, comprising:
a plurality of vehicles, each including:
a gear stick adapted to control gears therein;
hand brakes;
brake pedals;
a fuel tank having oil therein;
an engine having oil therein; and
a control system;
wherein said control system is adapted to mechanically control each of said gear stick, hand brakes, brake pedals, and said engine;
a system for remote control operation of said plurality of vehicles, comprising:
a plurality of wireless control devices, each including:
a global positioning satellite transmitter adapted to send positioning information to a remote communication device;
wherein each of said plurality of wireless control devices is adapted to be operably coupled to said control system of each respective one of said plurality of vehicles to thereby provide vehicle control instructions thereto; and
a remote communication device including:
a computing system;
wherein said computing system is adapted to remotely connect and communicate with each of said plurality of wireless control devices and thereby connect and communicate with each said control system of each respective one of said plurality of vehicles via an internet server; and
a global positioning satellite receiver;
wherein said global positioning satellite receiver is adapted to receive and register positioning information of each of said plurality of wireless control devices and thereby each of said plurality of vehicles;
wherein a user can use said remote communication device to control all of said plurality of vehicles at the same time.

32. The system for remote control operation of a plurality of vehicles of claim 31, wherein said remote communication device is selected from a group of remote communication devices consisting of a smartphone, a tablet, a laptop, and a desktop.

33. The system for remote control operation of a plurality of vehicles of claim 32, wherein said remote communication device includes a display screen; a processing unit; a computer-readable data carrier; and a computer application adapted to aid said user in using said remote communication device and thereby controlling all of said plurality of vehicles at the same time.

34. The system for remote control operation of a plurality of vehicles of claim 31, wherein said internet server uses an internet protocol chosen from a list of internet protocols consisting of Wi-fi, GPRS, and 3G.

35. The system for remote control operation of a plurality of vehicles of claim 31, wherein said control system of each respective one of said plurality of vehicles is adapted to control the position of its gear stick; the position of its hand brake; the position of its brake pedal; the level of oil in its fuel tank; the level of its engine oil; and is capable of turning its engine on and off.

36. The system for remote control operation of a plurality of vehicles of claim 35, further comprising a plurality of sensors; wherein respective said sensors are connected with components of each respective ones of said plurality of vehicles to determine said positions of respective said gear sticks; said positions of respective said hand brakes; said position of respective said brake pedals; said levels of oil in respective said fuel tanks; said levels of respective engine oil; and whether said engine is turned on or off; and wherein each of said plurality of sensors are adapted to send information to a respective said control system of each respective one of said plurality of vehicles.

37. The system for remote control operation of a plurality of vehicles of claim 36, further comprising a plurality of manual override switches each adapted to be connected to each respective engine of said plurality of vehicles to provide a manual means to switch between remote control of turning said engine on and off and manual override control of turning said engine on and off.

38. The system for remote control operation of a plurality of vehicles of claim 37, wherein said plurality of manual override switches each includes a key adapted to be inserted and turned therein to activate manual override of said remote control of said engine.

39. The system for remote control operation of a plurality of vehicles of claim 31, wherein said plurality of vehicles are selected from a group of vehicles consisting of trucks, buses, tractors, soil cultivators, and combines.
